(19) United States
(12) Patent Application Publication
(10) Pub. No.: US 2008/0105271 A1
(43) Pub. Date: May 8, 2008

(54) CHAKRA SKIN CARE MASK SYSTEM AND METHOD

(76) Inventors: VIVIAN VALENTY, Chandler, AZ (US); Marta Kaspar, Casa Grande, AZ (US)

Correspondence Address: WEISS & MOY PC, 4204 NORTH BROWN AVENUE, SCOTTSDALE, AZ, 85251, US

(21) Appl. No.: 11/555,971

(22) Filed: Nov. 2, 2006

(51) Int. Cl. A45D 33/00; A61Q 1/12

(52) U.S. Cl. 132/200; 206/38; 220/507

(57) ABSTRACT

A chakra skin care mask system is shown and described. The chakra skin care mask system includes a container that holds a plurality of jars, wherein each jar contains a skin care mask formulation corresponding to one of seven different chakra colors, including amethyst (violet), indigo, blue, emerald (green), yellow, orange, and red. In addition to the skin care mask formulations, the chakra skin care mask system may also include some other type of skin care treatment, such as a moisturizer, cream, cleanser, scrub, toner, or the like. A user of the chakra skin care mask system may choose a particular skin care mask formulation corresponding to one of the seven chakra colors, as desired, and apply it to the user's face, neck, or body. Prior to use of the skin care mask formulation, the user may desire to apply a skin care treatment, such as a cleanser, scrub or the like. Following use of the skin care mask formulation, the user may desire to apply a skin care treatment, such as a moisturizer, cream, toner, or the like.

### FIELD OF THE INVENTION

This invention relates generally to skin care treatments and, more particularly, to a skin care mask system that employs the seven basic chakras.

### BACKGROUND OF THE INVENTION

Chakras originated in the ancient Hindu system of healing dating before 2500 B.C. The chakra system has been used for thousands of years as an integral part of holistic healing. The word “chakra” signifies one of seven energy centers in the human body, corresponding to the seven main nerve centers which emanate from the spinal column. The seven basic chakras include Sahasrara, Ajna, Vishuddha, Anahata, Manipura, Swadhisthana, and Muladhara. Sahasrara relates to the crown, the element of space, and represents inner power or a connection to the divine. Ajna relates to the third eye, the element of time, and represents inner strength or intuition. Vishuddha relates to the throat, the element of life, and represents speech and self-expression. Anahata relates to the heart, lungs, and/or emotions and the element of air, and represents devotion, love, compassion, and healing. Manipura relates to the solar plexus and the element of fire, and represents mental functioning, power, control, freedom to be oneself, and career. Swadhisthana relates to the sacrum and the element of water, and represents emotion, energy, and creativity. Finally, Muladhara relates to the base or root and the element of the earth, and represents instinct, survival, and security. Each of the basic chakras is also associated with a particular color, as follows: Sahasrara—white or violet; Ajna—indigo; Vishuddha—blue; Anahata—medium or emerald green; Manipura—yellow; Swadhisthana—orange; and Muladhara—red.

Products employing the chakra system are known in the prior art, such as chakra crystals, chakra stones, and chakra jewelry. With respect to skin care products, chakra colors have been associated with such products on an individual basis. However, in the event that a user of a prior art chakra skin care product wishes to have available all the chakra colors, it would be necessary for the user to purchase different chakra colored products individually and then arrange them according to the chakra system. This is a disadvantage for users of such products, in that many users may not have an understanding of the chakra colors, including the number of chakra colors employed and their respective arrangements in the chakra system.

A need therefore exists for a chakra skin care mask system in which all of the colors in the chakra system are available to a user.

The present invention satisfies these needs and provides other, related advantages.

### SUMMARY OF THE INVENTION

In accordance with an embodiment of the present invention, a chakra skin care mask system is disclosed. The chakra skin care mask system comprises, in combination: a container; and a plurality of compartments contained within the container, wherein each of the plurality of compartments contains a different skin care mask formulation corresponding to one of seven chakra colors.

In accordance with another embodiment of the present invention, a chakra skin care mask system is disclosed. The chakra skin care mask system comprises, in combination: a container; and a plurality of compartments contained within the container, wherein each of the plurality of compartments contains one of a skin care treatment and a different skin care mask formulation corresponding to one of seven chakra colors.

In accordance with a further embodiment of the present invention, a method for treating the skin is disclosed. The method comprises the steps of: providing a chakra skin care mask system comprising, in combination: a container; and a plurality of compartments contained within the container, wherein each of the plurality of compartments contains a different skin care mask formulation corresponding to one of seven chakra colors; selecting a skin care mask formulation corresponding to one of the seven chakra colors; applying the skin care mask formulation to a face, neck, or body of a user; waiting a period of time for the skin care mask formulation to dry; and removing the skin care mask formulation from the face, neck, or body.

### BRIEF DESCRIPTION OF THE DRAWINGS

FIG. 1 is a front view of a chakra skin care mask system, consistent with an embodiment of the present invention.

FIG. 2 is a front view of a chakra skin care mask system, consistent with another embodiment of the present invention.

### DETAILED DESCRIPTION OF THE PREFERRED EMBODIMENTS

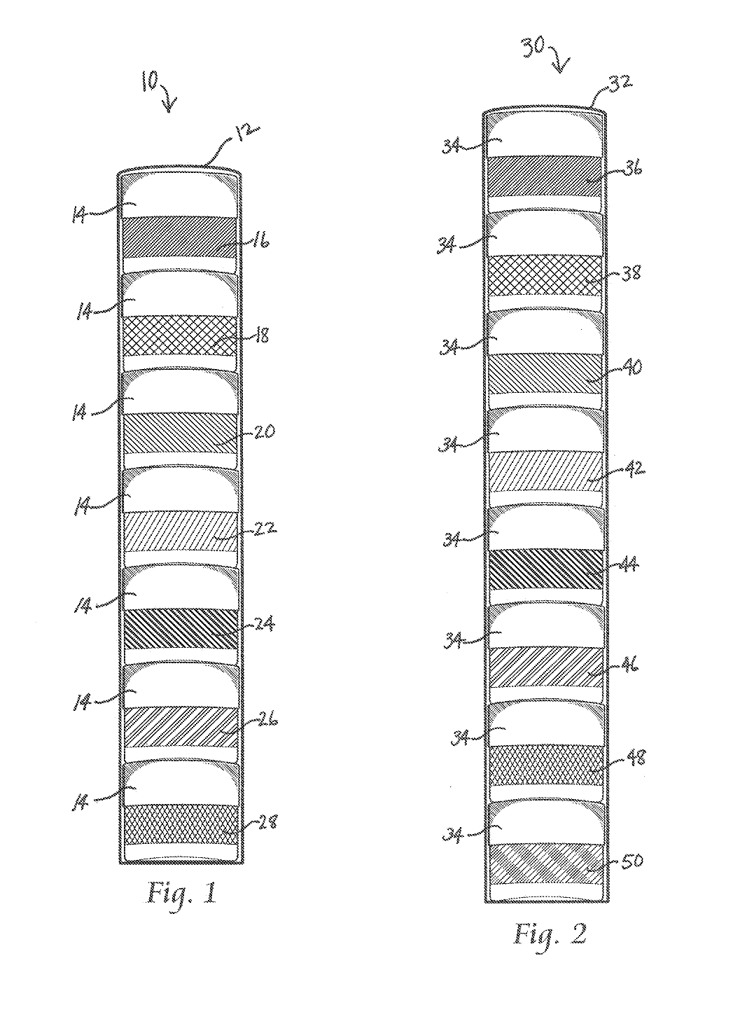

Referring first to FIG. 1, an embodiment of a chakra skin care mask system 10 consistent with an embodiment of the present invention is shown. The chakra skin care mask system 10 can be divided into the following principal components: a container 12 and a plurality of jars 14, with each jar 14 containing a skin care mask formulation.

In a preferred embodiment, the container 12 is tubular, but it should be understood that other shapes may be used for the container 12, without departing from the spirit and scope of the invention. The container 12 should be adapted to receive a plurality of jars 14. In the embodiment shown in FIG. 1, the jars 14 are positioned end to end within the container 12. However, it may be desired to position the jars 14 within the container 12 in a different manner, such as side by side. The container 12 is preferably made of a transparent material, such as plastic, acrylic, or the like. In this way, when the jars 14 are positioned in the container 12, different chakra colors (as discussed below) may be displayed to a user of the chakra skin care mask system 10.

With respect to the jars 14, in a preferred embodiment, each jar 14 is adapted to contain a skin care mask formulation. In the embodiment shown in FIG. 1, seven jars 14 are situated in the container 12. Preferably, each jar 14 contains a different skin care mask formulation that corresponds to one of seven colors in the chakra system. The embodiment shown in FIG. 1 includes skin care mask formulations with the colors of amethyst (violet) 16, indigo 18, blue 20, emerald (green) 22, yellow 24, orange 26, and red 28. The jars 14 may be composed of plastic, acrylic, glass, or some other desired material.

A user of the chakra skin care mask system 10 may choose a particular skin care mask formulation corresponding to one of the chakra colors, including amethyst (violet) 16, indigo 18, blue 20, emerald (green) 22, yellow 24, orange 26, and red 28, as desired. Preferably, any one of the skin care mask formulations may be applied to a user's face, neck, or body.

Turning now to FIG. 2, an embodiment of a chakra skin care mask system 30 consistent with an embodiment of the present invention is shown. As with the chakra skin care mask system 10, the chakra skin care mask system 30 can be divided into the following principal components: a container 32 and a plurality of jars 34, with each jar 34 containing a skin care mask formulation or some other skin care treatment.

In a preferred embodiment, the container 32 is tubular, but it should be understood that other shapes may be used for the container 32, without departing from the spirit and scope of the invention. The container 32 should be adapted to receive a plurality of jars 34. In the embodiment shown in FIG. 2, the jars 34 are positioned end to end within the container 32. However, it may be desired to position the jars 34 within the container 32 in a different manner, such as side by side. The container 32 is preferably made of a transparent material, such as plastic, acrylic, or the like. In this way, when the jars 34 are positioned in the container 32, different chakra colors (as discussed below) may be displayed to a user of the chakra skin care mask system 30.

With respect to the jars 34, in a preferred embodiment, each jar 34 is adapted to contain a skin care mask formulation or some other skin care treatment, such as a moisturizer, cream, cleanser, scrub, toner, or the like. In the embodiment shown in FIG. 2, eight jars 34 are situated in the container 32. Preferably, seven of the jars 34 each contain a different skin care mask formulation that corresponds to one of seven colors in the chakra system. The embodiment shown in FIG. 2 includes skin care mask formulations with the colors of amethyst (violet) 36, indigo 38, blue 40, emerald (green) 42, yellow 44, orange 46, and red 48. Preferably, one of the jars 34 contains a skin care treatment, such as a moisturizer 50, as shown in FIG. 2. While eight jars 34 are shown in the embodiment in FIG. 2, it may be desired to include more than eight jars 34 in the chakra skin care mask system 30. The jars 34 may be composed of plastic, acrylic, glass, or some other desired material.

A user of the chakra skin care mask system 30 may choose a particular skin care mask formulation corresponding to one of the chakra colors, including amethyst (violet) 36, indigo 38, blue 40, emerald (green) 42, yellow 44, orange 46, and red 48, as desired. Preferably, any one of the skin care mask formulations may be applied to a user's face, neck, or body. Prior to use of a skin care mask formulation, a user may desire to apply a skin care treatment such as a cleanser, scrub, or the like. Following use of a skin care mask formulation, a user may desire to apply a moisturizer 50 or some other type of skin care treatment.

While the invention has been particularly shown and described with reference to the preferred embodiments thereof, it will be understood by those skilled in the art that the foregoing and other changes in form and details may be made therein without departing from the spirit and scope of the invention. For example, instead of the container 12 and jars 14, it may be desired to employ a compartmentalized container, wherein each compartment is adapted to hold a different skin care mask formulation corresponding to one of the seven chakra colors. In such an instance, the jars 14 would not be required. Similarly, instead of the container 32 and jars 34, it may be desired to employ a compartmentalized container, wherein each compartment is adapted to hold either a different skin care mask formulation corresponding to one of the seven chakra colors or some other type of skin care treatment, such as a moisturizer, cream, cleanser, scrub, toner, or the like. In such an instance, the jars 34 would not be required.

I claim:

1. A chakra skin care mask system comprising, in combination:
a container; and
a plurality of compartments contained within the container, wherein each of the plurality of compartments contains a different skin care mask formulation corresponding to one of seven chakra colors.

2. The system of claim 1 wherein the container is tubular.

3. The system of claim 1 wherein each compartment is ajar.

4. The system of claim 1 wherein the chakra colors are violet, indigo, blue, green, yellow, orange, and red.

5. A chakra skin care mask system comprising, in combination:
a container; and
a plurality of compartments contained within the container, wherein each of the plurality of compartments contains one of a skin care treatment and a different skin care mask formulation corresponding to one of seven chakra colors.

6. The system of claim 5 wherein the container is tubular.

7. The system of claim 5 wherein each compartment is a jar.

8. The system of claim 5 wherein the skin care treatment is one of a moisturizer, cream, cleanser, scrub, and toner.

9. The system of claim 5 wherein the chakra colors are violet, indigo, blue, green, yellow, orange, and red.

10. A method for treating the skin comprising the steps of:
providing a chakra skin care mask system comprising, in combination:
a container; and
a plurality of compartments contained within the container, wherein each of the plurality of compartments contains a different skin care mask formulation corresponding to one of seven chakra colors;
selecting a skin care mask formulation corresponding to one of the seven chakra colors;
applying the skin care mask formulation to a face, neck, or body of a user;
waiting a period of time for the skin care mask formulation to dry; and
removing the skin care mask formulation from the face, neck, or body.

11. The method of claim 10 wherein the container is tubular.

12. The method of claim 10 wherein each compartment is ajar.

13. The method of claim 10 wherein the chakra colors are violet, indigo, blue, green, yellow, orange, and red.

14. The method of claim 10 wherein one of the plurality of compartments contains a skin care treatment.

15. The method of claim 12 comprising eight jars.

16. The method of claim 14 wherein the skin care treatment is one of a moisturizer, cream, cleanser, scrub, and toner.

17. The method of claim 10 further comprising the step of applying one of a cleanser or scrub to the face, neck, or body prior to the step of applying the skin care mask formulation.

18. The method of claim 10 further comprising the step of applying one of a moisturizer, cream, or toner to the face, neck, or body.

19. The method of claim 10 wherein the chakra colors are violet, indigo, blue, green, yellow, orange, and red.
